(19) United States
(12) Patent Application Publication
(10) Pub. No.: US 2016/0048548 A1
(43) Pub. Date: Feb. 18, 2016

(54) POPULATION OF GRAPH NODES

(71) Applicant: Microsoft Corporation, Redmond, WA (US)

(72) Inventors: Satish J. Thomas, Sammamish, WA (US); Murtaza Muidul Huda Chowdhury, Bellevue, WA (US)

(21) Appl. No.: 14/458,951

(22) Filed: Aug. 13, 2014

(51) Int. Cl. G06F 17/30

(52) U.S. Cl. CPC G06F 17/30351; G06F 17/30539

(57) ABSTRACT

Crawlers crawl disparate sources of information and build a graph that identifies relationships between entities. The graph can be manually updated by users. Where two or more users attempt to make competing updates to the same information in the graph, a prevailing update is identified based upon the user's proximity to the entity being changed.

### BACKGROUND

An organization may use one or more computer systems. The different computer systems may be used for different purposes, by different people, and therefore each system may contain its own data.

Some such computer systems include business systems. Business systems can include, for example, customer relations management (CRM) systems, enterprise resource planning (ERP) systems, line-of-business (LOB) systems, among others. These systems can store data records (such as entities) corresponding to items within the business system, and they can run business processes, workflows, or other business logic on the data records so that users can perform the tasks or activities in order to carry out the function of the business. Entities can be objects that represent a wide variety of different types of things within a business system. For instance, a customer entity can represent and describes a customer. A vendor entity can represent and describe a vendor. A product entity can represent and describe a product. A quote entity can represent and describe a quote. A business opportunity entity can represent and describe a business opportunity. These are examples only, and a wide variety of other entities can be used as well.

The data or other information can exist in disparate applications sourced for different business functions. Some of those functions include sales, marketing, customer service, e-commerce, among others. Because each of these different applications or systems has its own data, the data for a single entity may be different, depending on the application. For instance, the data representing customer A in a sales system may be different from the data representing customer A in a licensing system. In fact, it is not uncommon for these types of different representations to exist in many (perhaps 40-50 or more) different systems for a single organization. This can present certain challenges.

For instance, it may be that a person from customer A contacts a customer service representative for the organization that is using the business system, where the customer service representative resides in Japan. The customer service representative may not know that customer A is the organization's highest paying customer because that information is stored in a sales system while the customer service representation is using a customer service system. However, this type of information could be very useful to the customer service representative.

The problem is exacerbated because many organizations have complicated relationships with one another. For instance, customer A may have a financial relationship with the organization using the business system as well as a contractual or transactional relationship. Similarly, customer A may have certain usage patterns with the organization that are not captured in either the financial or contractual contexts. In some cases, customer A may be both a customer and a vendor of the same organization. All of these types of complicated relationships can make it even more difficult to understand, in a comprehensive sense, how customer A relates to the organization that deploys the business system.

The discussion above is merely provided for general background information and is not intended to be used as an aid in determining the scope of the claimed subject matter.

### SUMMARY

Crawlers crawl disparate sources of information and build a graph that identifies relationships between entities. The graph can be manually updated by users. Where two or more users attempt to make competing updates to the same information in the graph, a prevailing update is identified based upon the user's proximity to the entity being changed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A and 1B (collectively referred to as FIG. 1) show a block diagram of one example of a business system architecture.

FIG. 2 is a block diagram of one example of an edge in a graph.

FIGS. 3A and 3B (collectively referred to as FIG. 3) show a flow diagram illustrating one example of the operation of the architecture shown in FIG. 1 in making a system update to the graph.

FIGS. 4A and 4B (collectively referred to as FIG. 4) show a flow diagram illustrating one example of the operation of the architecture in FIG. 1 in making manual updates and resolving competing updates, to the graph.

FIGS. 4C-4F show examples of user interface displays.

FIG. 5 is a block diagram showing one example of the architecture shown in FIG. 1, deployed in a cloud computing architecture.

FIGS. 6-8 show various examples of mobile devices.

FIG. 9 is a block diagram of one example of a computing environment.

### DETAILED DESCRIPTION

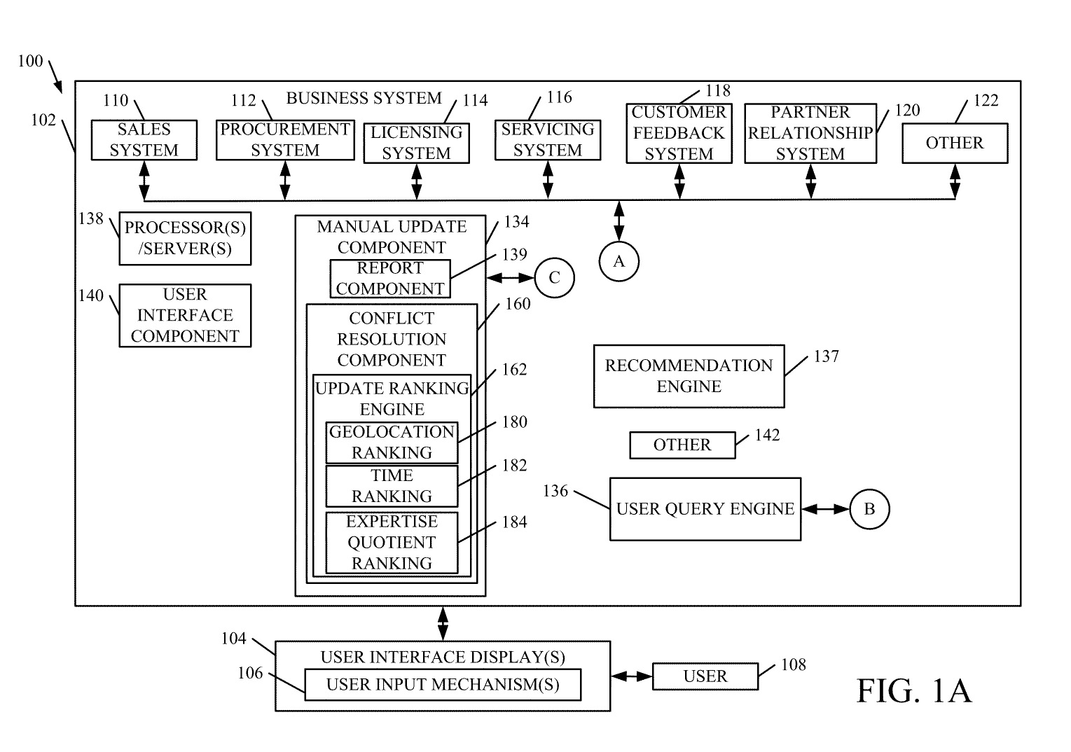

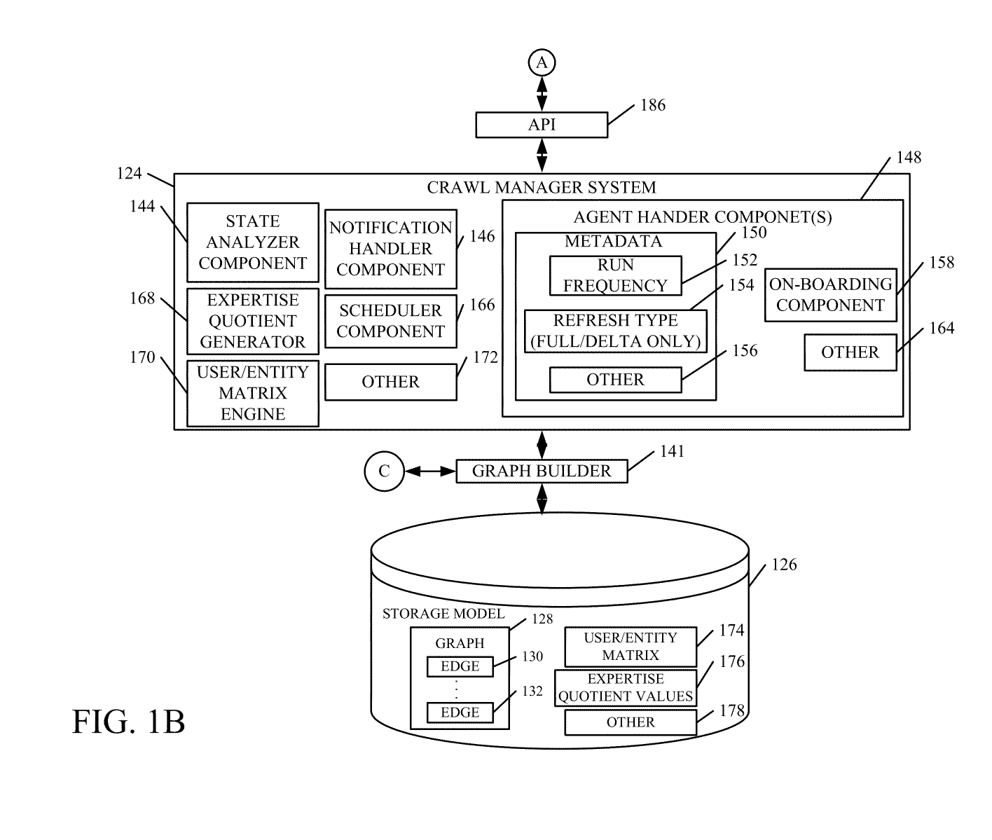

FIG. 1 is a block diagram of one example of a business system architecture 100. Architecture 100 illustratively includes business system 102 that generates user interface displays 104, with user input mechanisms 106, for interaction by one or more users 108. In the example illustrated, business system 102 includes a plurality of systems with which different users 108 can interact with system 102. For instance, business system 102 is shown as including sales system 110, procurement system 112, licensing system 114, servicing system 116, customer feedback system 118, partner relationship system 120 and it can include other systems 122 as well.

Business system 102 also illustratively includes crawl manager system 124, storage model 126, manual update component 134, user query engine 136, recommendation engine 137, processors or servers 138, user interface component 140, graph builder 141, and it can include other items 142, as well. Crawl manager system 124, itself, illustratively includes state analyzer component 144, notification handler component 146, agent handler component 148 (which themselves include metadata 150 that includes run frequency information 152, refresh type (full/delta only) information 154, and possibly other information 156), on-boarding component 158, and it can include other items 164 as well. Business system 102 further illustratively includes scheduler component 166, expertise quotient generator 168, user/entity matrix engine 170, and it can include other items 172. Storage model 126, itself, illustratively includes graph 128 that has edges 130-132, user/entity matrix 174, expertise quotient values 176, and it can include other items 178. Manual update component 134 can include conflict resolution component 160 and report generator 139. Conflict resolution component 160 can include update ranking engine 162 which can use various ranking components (such as geolocation ranking component 180, time ranking component 182, expertise quotient ranking component 184, or others). Before describing the overall operation of business system 102 in more detail, a brief overview will first be provided.

Sales system 110 can be used by sales users to conduct sales activities. Procurement system 112 can be used by users to conduct procurement activities. Licensing system 114 can be used to perform licensing activities. Servicing system 116 can be used to perform customer service or other activities. Customer feedback system 118 can be used to provide customer feedback channels. Partner relationship system 120 can be used to perform various partner relationship activities. All of these activities can be performed with respect to the organization that is using business system 102. These types of activities can be performed by a wide variety of different users.

In addition, each system 110-122 can have its own data representing the various other organizations or individuals that interact with the organization that deploys business system 102. For instance, sales system 110 may have customer data that represents the sales customers of the organization that deploys business system 102. The sales customers are illustratively represented by a customer entity within sales system 110. The customer entity in sales system 110 may describe the contacts, address, and other information for the customer in a certain way.

At the same time, the organization that uses business system 102 may also have licensing agreements with the same customer. In that case, licensing system 114 illustratively includes an entity that represents the customer, from a licensing perspective. Therefore, the contacts, relationship information, and other information corresponding to the customer entity in licensing system 114 may be different than that for the same customer in sales system 110. By way of example, the customer information for the customer entity in sales system 110 may include a gross annual sales number for the given customer, indicating how large the customer is with respect to the organization deploying business system 102. However, licensing system 114 may not have that same type of information. Therefore, a user 108 who is in contact with the customer through licensing system 114 may have no idea that the customer is a very large customer of the organization, because that information is in sales system 110.

Therefore, business system 102 also illustratively includes a crawl manager system 124 that crawls the data in the various data sources (or systems) 110-122 and generates a comprehensive view of the entities stored in those systems, and stores it in storage model 126, as graph 128 (which itself, includes a plurality of different edges 130-132). This is described in greater detail below.

In addition, business system 102 illustratively includes manual update component 134 that allows various users 108 of different systems 110-122 to update the information (e.g., the edges) in graph 128, when a user sees that information needs to be updated. In doing so, manual update component 134 can user query engine 136 to allow a user to conduct a query against data sets in storage model 126. In response, query engine 136 returns the results to manual update component 134 where they can be updated and rewritten to storage model 126.

It may be that two or more users might attempt to update the same information in graph 128. In that case, conflict resolution component 160 illustratively employs update ranking engine 162 to resolve the conflict, and to identify a prevailing update that will be made to the corresponding edge in graph 128. In doing so, engine 162 can run geolocation ranking component 180 that ranks the updates based on how close (in geographical proximity) the competing users (attempting to make the conflicting updates) are to the entity being updated. Engine 162 can also include time ranking component 182 that ranks the most recent update higher than earlier updates. Engine 162 can include expertise quotient ranking component 184 as well. Component 184 illustratively determines which of the competing users has a higher expertise quotient relative to the entity being changed. It ranks the updates from that user higher than the competing updates.

It will also be noted that, in one example, crawl manager system 124 exposes API 186. Therefore, any new data sources (in addition, for instance, to systems 110-122) can easily be added to augment the information in storage model 126. The new data source simply needs to write to API 186 (or implement API 186) and the data from the new data source will be crawled by crawl manager system 124, and it will be included in storage model 126. Because the data sources use API 186, the system is not dependent on any schema of any newly on-boarded data sources. This improves the accuracy of the comprehensive view of entities in the graph 128, and it makes the system highly scalable and extensible.

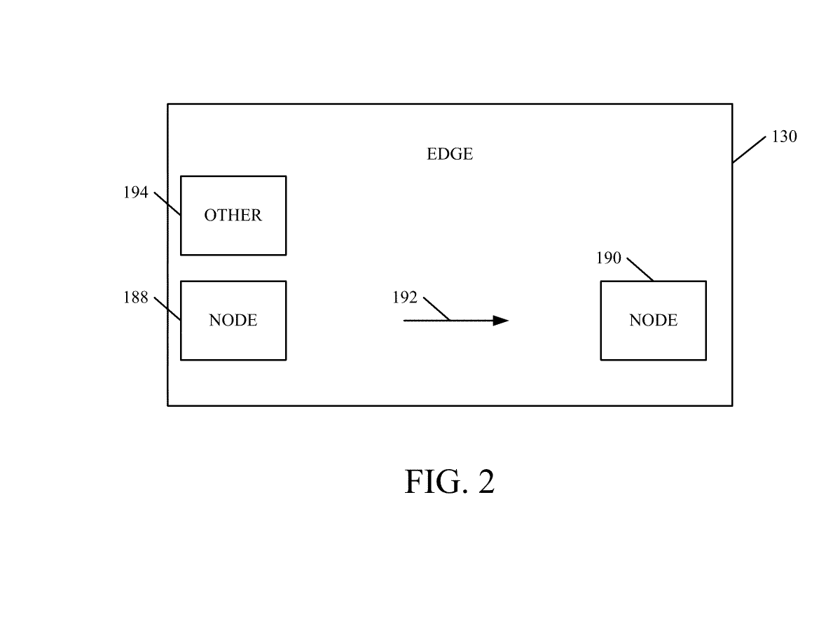

FIG. 2 is a block diagram of a more detailed example of an edge (such as edge 130) in graph 128. In the example shown in FIG. 2, the information stored in graph 128 is stored as triples that represent graph edges, such as edge 130. Each edge illustratively includes a set of nodes 188 and 190, connected by a directional connection 192. The edge can include other information 194 as well. In one example, node 188 can represent a subject, arrow 192 can represent a property, and node 190 may represent a value. Other information 194 can include (for example) the subject type and the value type.

As a specific example, the subject may be “customer A”. The property may be “is based out of”, and the value may be “France”. In that case, the subject type may be “customer” and the value type may be “country”. Thus, the edge may appear as follows.

Customer A—is based out of—France, subject type=customer, value type=country.

Of course, this is only one example of an edge, and a wide variety of other edges can be used as well.

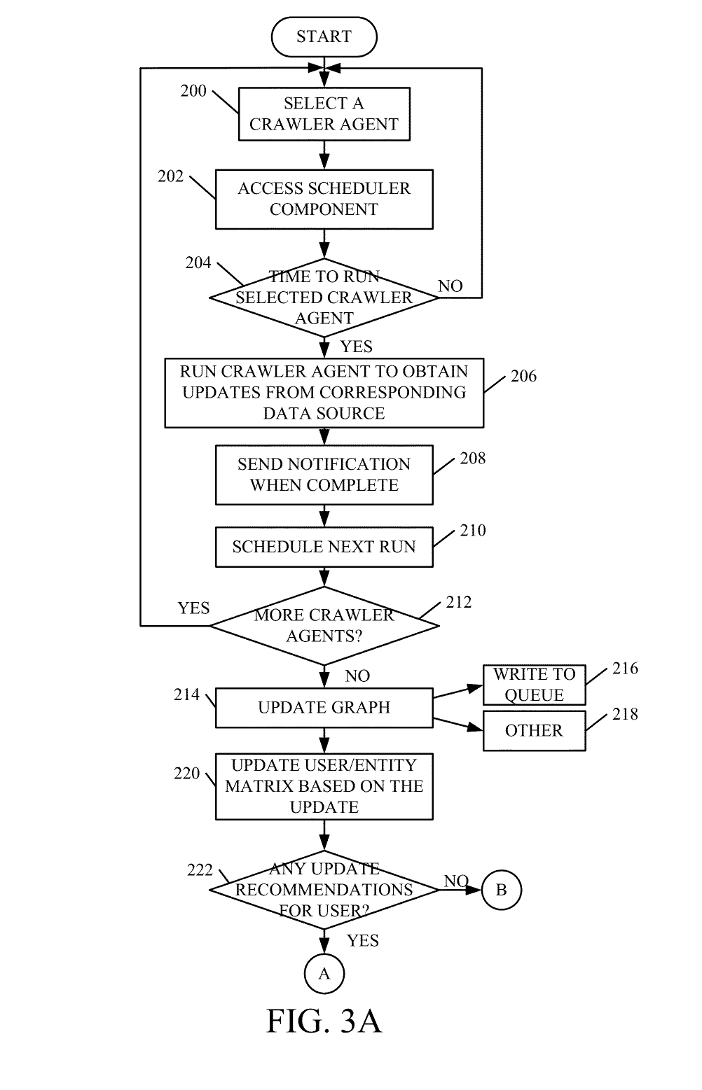

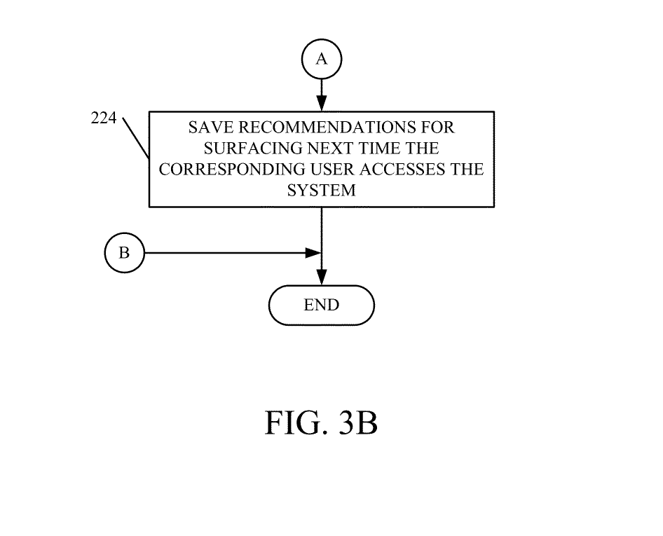

FIGS. 3A and 3B show one example of the operation of crawl manager system 124 in automatically updating graph 128 in storage model 126 by crawling the various data sources or systems 110-122 for new data. It is assumed that the various data sources have already been crawled and graph builder 141 has built a graph 128. It will first be noted that, in one example, crawl manager system 124 has a plurality of different agent handler components (or crawler agent) 148, that are each configured to crawl a different data source 110-122. State analyzer component 144 illustratively monitors state changes of the various data sources 110-122 and crawls the data sources, as desired. In doing so, it first selects a crawler agent 148 for the data source to be crawled. This is indicated by block 200 in FIG. 3. Scheduler component 166 keeps a schedule of when the various crawler agents are to be run on their corresponding data sources. State analyzer component 144 thus accesses scheduler component 166 to determine whether it is time to run the selected crawler agent. This is indicated by blocks 202 and 204 in FIG. 3.

In determining whether it is time to run the crawler agent, state analyzer component 144 illustratively accesses metadata 150 in the selected agent handler component 148. The metadata 150 illustratively includes run frequency information 152 which indicates how frequently the agent handler component is to be run. It can also include refresh type information 154 which indicates whether the agent handler component is to perform a full refresh of the data from the corresponding source, meaning that it will rewrite all information is the corresponding entities in graph 128 based upon the information that is identified when it crawls the corresponding data source. The refresh type may also be a delta only refresh type, meaning that the agent handler component 148 will rewrite only those portions of the entities for which the corresponding information in the data source being crawled has changed.

If it is not time for the selected agent to crawl its data source, then processing reverts to block 200 where state analyzer component 144 selects another crawler agent. If it is time to run the selected agent handler component, then state analyzer component 144 runs the selected crawler agent to obtain updates from the corresponding data source. This is indicated by block 206. In one example, the agents 148 crawling data sources and obtaining updates from multiple different data sources can be run asynchronously.

When a crawler agent 148 finishes crawling the corresponding data source, notification handler component 146 sends a notification to scheduler component 166, so that scheduler component 166 can schedule the next run for the corresponding crawler agent handler component 148. Sending the notification and scheduling the next run are indicated by blocks 208 and 210 in the flow diagram of FIG. 3.

State analyzer component 144 then determines whether there are more crawler agents to select. This is indicated by block 212. If so, the processing reverts to block 200 where another crawler agent is selected.

In one example, each of the crawler agent handler components 148 can be written to include on-boarding component 158, so that they can on-board a data source of substantially any type. In one example, the agent handlers 148 are illustratively defined in a markup language (such as XML) for ease of on-boarding and performing manual updates. Table 1 below shows one example of the XML that defines the agent handler component 148.

```
TABLE 1
<?xml version=“1.0” encoding=“utf-8”?>
<crawleragents>
  <crawleragent type=“ insert agent type” name=“ insert name” updatefrequency=“weekly”
deltasync=“false”>
    <source>
      <query name=“insert query name” filepath=“\\insert file path” sheet=“first” />
    </source>
    <destination>
      <querymapper source=“insert name” name=“CustomerPurchasedProduct”>
        <subject>Customer</subject>
        <property>purchased</property>
        <value>Product</value>
      </querymapper>
    </destination>
  </crawleragent>
<crawleragent type=“insert agent type” name=“insert name” updatefrequency=“hourly”
deltasync=“true”>
<source>
          <query name=“insert query name” connectionString=“insert connection string”
      providerName=“insert provider name”/>
    </source>
<destination>
  <querymapper source=“insert source” name=“CustomerRegion”>
    <subject>Customer</subject>
    <property>is based out of</property>
    <value>Region</value>
  </querymapper>
</destination>
</crawleragent>
            </crawleragents>
```

It can be seen in Table 1, that the XML first defines the type of data and that the node being updated in graph 128 is the customer node. The first edge corresponds to “customer—purchased—product”. The update frequency is set, and the update type (or refresh type) is set as well.

Another edge for the customer is also defined. It is the “customer—is based out of—region”.

It will be appreciated that the agent handler components 148 can be defined in a wide variety of different ways. Table 1 is just one example.

Referring again to the flow diagram of FIG. 3, once the information is obtained from the various crawler agents 148, then the agent handler updates the graph 128 in storage model 126 by providing the updates to graph builder 141. This is indicated by block 214 in FIG. 3. In one example, because the data can be updated from multiple different data sources, asynchronously, the updates can first be written to a queue as indicated by block 216, so that they can be made sequentially. Of course, the graph can be updated in other ways well, as indicated by block 218.

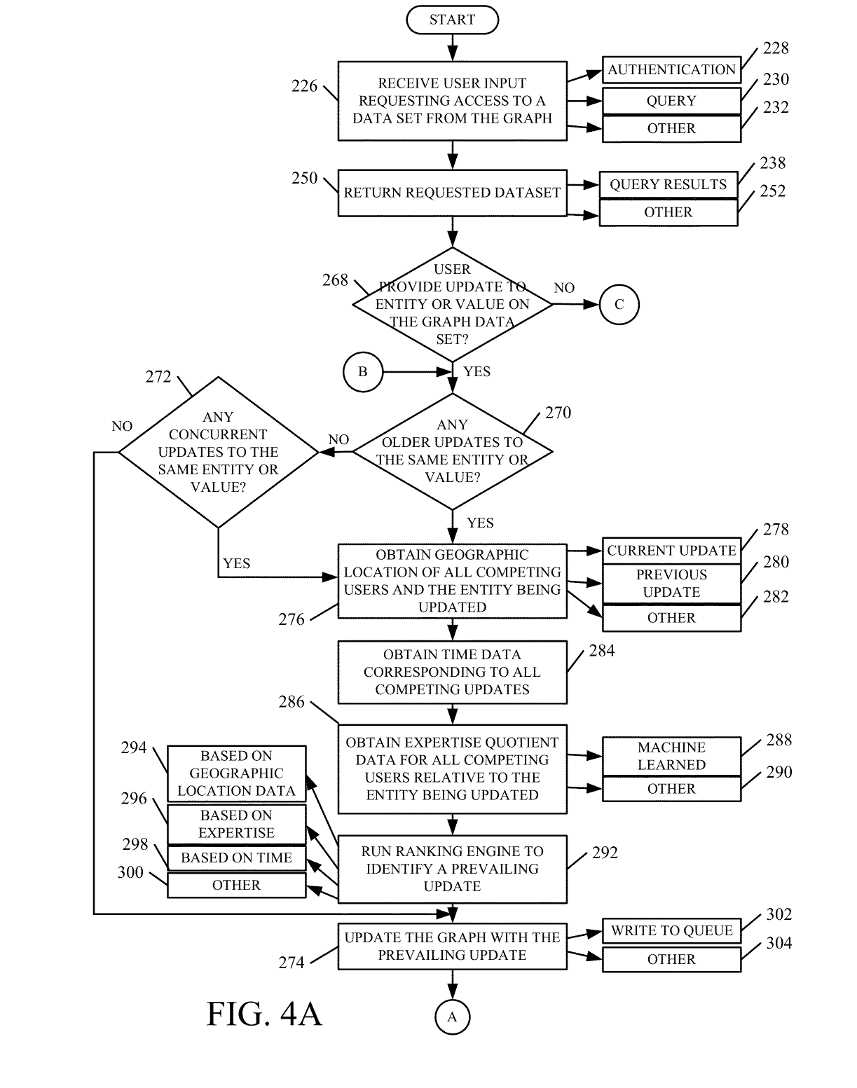

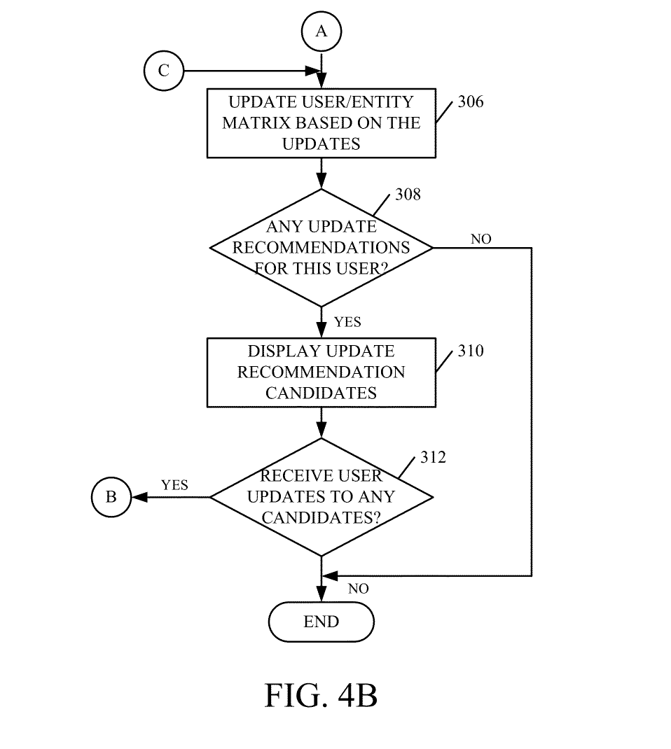

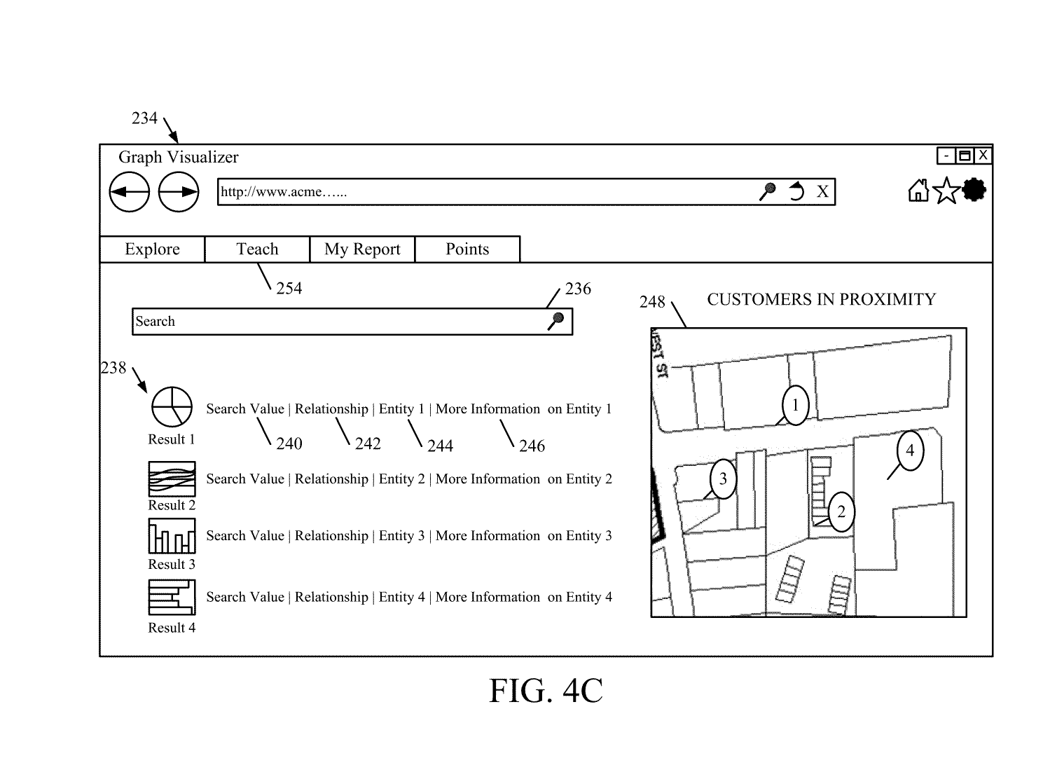

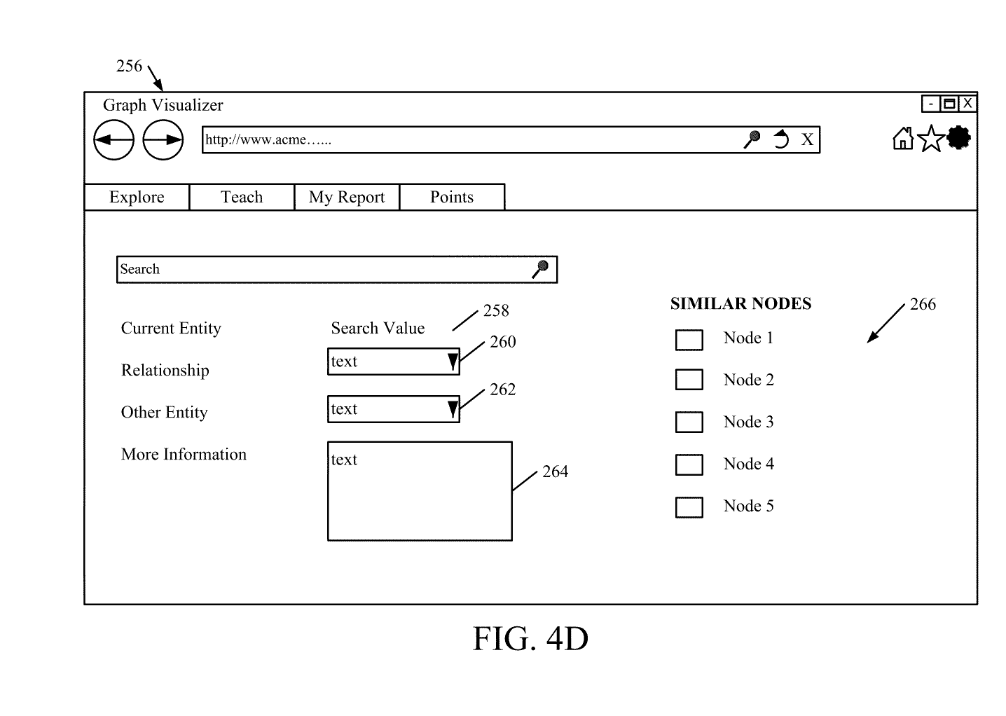

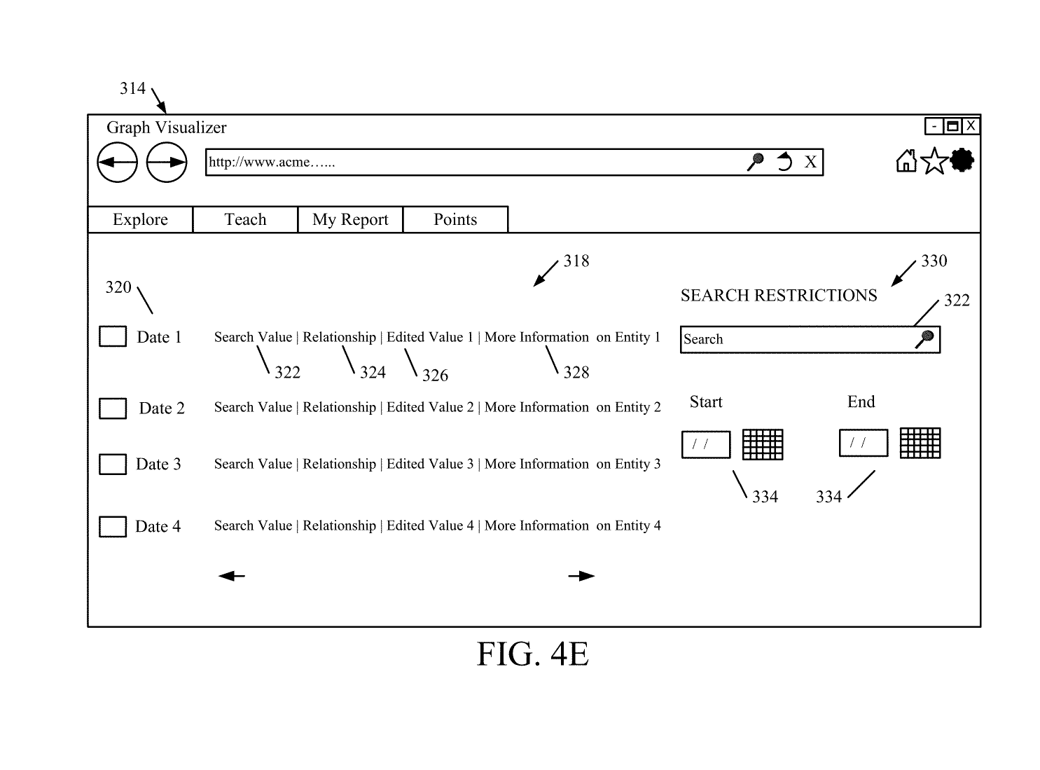

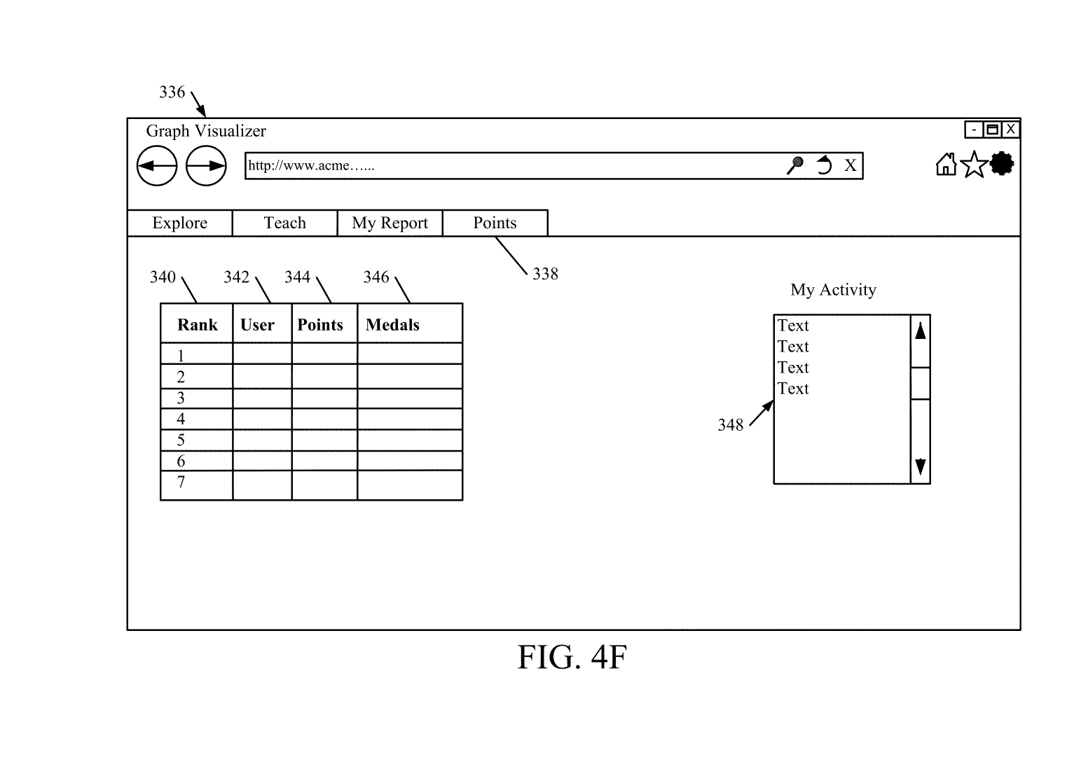

If conflicting changes are identified, the conflict can be resolved using conflict resolution component 160. This is described in greater detail below with respect to FIG. 4.

User/entity matrix engine 170 then updates user/entity matrix 174 in storage model 126. User/entity matrix 174 is a matrix that indicates which users have updated, or are otherwise related to, which entities in graph 128. This can be used in collaborative filtering environments in which a plurality of different users can provide updates to the various entities in graph 128. Updating the user/entity matrix based upon the update that has been written to storage model 126 is indicated by block 220 in FIG. 3.

In one example, user/entity matrix 170 also calculates recommendation candidates for various users. As an example, engine 170 can use a machine learning algorithm to identify various users of business system 102 that may be credible or have expertise with respect to various entities in the system. It may be that one of those users has changed one of the entities. In that case, users of the other portions of the business system 102 (e.g., users of the other data sources 110-122) may wish to update the corresponding record in their corresponding systems as well. Thus, engine 170 calculates recommendation candidates that should be changed by various users. When those users next log on to the system, the recommendation candidates can be surfaced for them to see whether those users wish to make the corresponding changes. Determining whether there are any update recommendations for the various users based on the most recent changes is indicated by block 222. If so, saving the recommendations for surfacing next time the corresponding user accesses the system is indicated by block 224.

In addition to recommendations being made for other users, it may be that certain nodes in graph 128 are highly related to other nodes. Where an update is made to one of the nodes, it may be that engine 170 generates recommendations to be made to the other, closely related, nodes as well.

FIGS. 4A and 4B (collectively FIG. 4) show a flow diagram illustrating one example of the operation of manual update component 134 in allowing users of the various data sources 110-122, or other users of business system 102, to make updates to the graph 128 in storage model 126. Component 134 first receives a user input requesting access to a data set from graph 128. This is indicated by block 226 in the flow diagram of FIG. 4. For instance, the user can first log onto system 102 by providing authentication information 228. The user can then provide a query 230 through user query engine 136, to query storage model 126. The user can provide other inputs 132 in order to access a data set from graph 128 as well.

FIG. 4C is one example of a user interface display 234 that illustrates this. It can be seen that user interface display 234 includes a text box 236 that can be generated by manual update component 134, and that allows the user to input a search value for searching graph 128. In response, component 134 can use user query engine 136 to execute the query against graph 128 and return results, which are shown generally at 238 in FIG. 4C. Each result illustratively identifies the search value at 240, a relationship at 242, and an entity at 244 that meets the relationship 242 relative to the search value 240. The search result can also include additional information for the corresponding entity, as indicated generally at 246. Further, the search results can include a map 248, or other information that graphically shows the various results 238 with respect to the map or other graph 248.

Returning the requested data set is indicated by block 250 in FIG. 4. These can include query results 238 or other information 252.

It may be that the user wishes to make a modification or update to one of the retuned search results. In that case, the user illustratively selects one of the search results 238 and actuates the “teach” tab 254 on user interface display 234. In response, manual update component 134 illustratively generates a user interface display such as display 256 shown in FIG. 4D. User interface display 256 displays a current entity corresponding to the search value at 258. It then allows the user to modify the relationship information using input mechanism 260, the related entity information using mechanism 262, and the additional information field, using entity 264. User interface display 256 also illustratively displays a set of similar nodes 266, which can be actuated by the user to make corresponding updates, if desired.

In any case, the user illustratively makes an update to the data set. This is indicated by block 268 in the flow diagram of FIG. 4.

Before writing that update to a queue or otherwise to storage model 126, manual update component 134 first determines whether any older updates have been made to the same entity or value, in the past. This is indicated by block 270 in FIG. 4. If not, then manual update component 134 determines whether there are any concurrent updates pending, to the same entity or value. This is indicated by block 272. If not, processing continues at block 274 where the graph is updated with the current update information.

However, if the answer at either block 270 or 272 is yes, then there are two different, conflicting updates that are attempting to be made to the same information in graph 128. Thus, conflict resolution component 160 obtains information from graph 128 or from another system about the users who initiated the changes. In the example shown in FIG. 4, conflict resolution component 160 first obtains the geographic location of all of the competing users who initiated the conflicting changes, and the entity that is being updated. This is indicated by block 276 in FIG. 4. The geographic location of the users and the entity being updated can be obtained for the current update being processed as indicated by block 278. That may include obtaining the geographic location of the current user attempting to make the current update, as well as the geographic information for entity being updated. By way of example, if the current user resides in city A and is attempting to update a customer entity for a customer that resides in city B, then both the location information for the user (city A) and the location information for the entity being updated (city B) will be obtained. The same information will be obtained for all competing updates. That is, the location of the user attempting to make the competing update will be obtained as well. Further, if other previous updates were made, the information will be obtained for the users who made the previous updates, as indicated by block 280. The geographic location information can be obtained for other items as well, and this is indicated by block 282.

Conflict resolution component 160 also illustratively obtains time data corresponding to all of the competing updates. For instance, each competing update will have a corresponding timestamp indicating when it was made. This information can be stored in graph 128, a queue that holds pending updates, or elsewhere. Obtaining this information is indicated by block 284 in FIG. 4.

In addition, conflict resolution component 160 will obtain expertise quotient data 176 corresponding to users that are attempting to make the changes to the given entity. This is indicated by block 286. By way of example, and as briefly mentioned above, different users may interact frequently with different entities. In addition, when certain users make changes to an entity in graph 128, those changes may last for a long time, before they are superseded by other changes. Alternatively, a user may act only infrequently with respect to a given entity, and that user's changes may be over written or otherwise modified, quickly. This type of information can illustratively be used by expertise quotient generator 168 (which can be implemented as a machine learning system or another type of system) to obtain an expertise quotient for the various users, with respect to the entity being changed. If a user's expertise quotient is higher than that for competing users, relative to the changed entity, that may indicate that the user is more credible in making changes to that entity. On the other hand, if the user's expertise quotient is relatively low with respect to the entity being changed, it may indicate that the user is not as credible, in making the change. Obtaining the expertise quotient as machine learned information is indicated by block 288 in FIG. 4, and obtaining it in other ways is indicated by block 290.

Once the information is obtained, update ranking engine 162 ranks the updates to identify a prevailing update, that will be made to graph 128, from the competing updates. This is indicated by block 292 in FIG. 4. In one example, engine 162 can rank the updates by running geolocation ranking component 180, which identifies an update as ranking higher if the user making the update is located geographically closer to the entity being updated, than for other updates. For instance, assume user A is updating the address information in the entity for customer A, and user A is located one block away from customer A. Assume also that user B is attempting to update the address information in the entity for customer A, but user B is located 1,000 miles away from customer A. This tends to indicate that user A is more credible in making changes to the address field of customer A, than is user B. Thus, geolocation ranking component 180 would rank the change being made by user A higher than the change being made by user B. Ranking the results based upon the geographic location data is indicated by block 294 in FIG. 4.

Update ranking engine 162 can run other ranking components as well, to rank the data in other ways. Further, engine 162 can run multiple different ranking components and combine the results to obtain an overall ranking of the updates.

For instance, engine 162 can run expertise quotient ranking component 184 that ranks the update based upon the expertise quotients of the users attempting to make those updates. For instance, if user A has a higher expertise quotient relative to the entity being updated than user B does, then the updates being made by user A will be ranked higher than those being made by user B. In addition, engine 162 can run time ranking component 182. Component 182 illustratively ranks more recent updates higher than older updates. Thus, if user A is attempting to make a change to the customer entity today, but user B made the last change to the customer entity six months ago, then component 182 would rank the updates of user A higher than the updates of user B. Ranking the updates based on expertise is indicated by block 296. Ranking the updates based upon the time at which they were made is indicated by block 298. Ranking the updates in other ways is indicated by block 300.

It will be noted that, where update ranking engine 162 combines the ranking results from various update components, it can do so using voting logic, using weights, or in other ways. For instance, if two components rank one update higher than a third component, then that update may prevail, because it was ranked higher by the most ranking components. On the other hand, the output of the ranking components can be weighted. The weights and corresponding ranks can be summed (or otherwise combined) to identify the prevailing updates. Other ways of combining the outputs of the update ranking components can be used as well.

Once the prevailing update is identified, manual update component 134 updates the graph 128 with the prevailing update. This is indicated by block 274. Again, because updates can be made from different data sources asynchronously, component 134 may first write the update to a queue, as indicated by block 302, so that the order in which the updates were made can be maintained. Component 134 can write the update to graph 128 in other ways as well, and this is indicated by block 304.

User-entity matrix engine 170 then updates the user/entity matrix 174 based upon the update. This is indicated by block 306 in FIG. 4. For instance, it may update the user/entity matrix to indicate that a given user has again interacted with a given entity. It may update matrix 174 to indicate which users attempted to make the competing changes and which prevailed. The matrix can be updated in other ways as well.

User/entity matrix engine 170 then determines whether there are any recommendations to be made for this user. This is indicated by block 308. For instance, if the user just finished updating an address for a product entity corresponding to a customer, the user may also wish to make that update to the customer entity as well. Recommendation engine 137 thus calculates and displays update recommendation candidates for this user. This is indicated by block 310 in FIG. 4. If the user elects to make updates to the recommendation candidates, then the user provides those updates and processing reverts to block 270 where it is determined whether the updates are conflicting with any other updates, etc. This is indicated by block 312 in FIG. 4.

Because recommendation engine 137 recommends updates based upon the user's previous updates, this makes the recommended updates contextual. For instance, because user A has made updates to a certain subset of entities, and that subset is closely related to another entity in graph 128, recommendation engine 137 uses the context information (of the previously updated entities for this user) to recommend additional updates that are closely contextually related to this user's previous updates.

Manual update component 134 can also provide a number of other features.

Report component 139 can generate reports based on the user's previous updates, and expertise quotient generator 138 can also display a ranked list of experts relative to an entity, a set of entities, or system 102, as a whole.

FIG. 4E, for instance, shows one example of a user interface display 314 that can be generated by report component 139. It can be generated, or displayed, in response to the user actuating reports tab 316. In the example shown in FIG. 4E, display 314 shows a list of recent edits 318 that this user has made to various entities, arranged by date. It not only includes the date 320, but the entity 322, relationship 324, and edited value 326 for the edit. It further includes additional information 328 with respect to the entity that was edited. In the example shown in FIG. 4E, user interface display 314 also illustratively includes a search mechanism 330. It allows the user to enter search keywords in box 332 and to filter the search results by date, using mechanisms 334. Of course, this is only one example of the various reports that can be generated by report component 139.

FIG. 4F shows another example of a user interface display 336 that can be generated by expertise quotient generator 168. It can be generated, or displayed, in response to the user actuating the points tab 338. In the example illustrated, expertise quotient generator 168 illustratively calculates an overall expertise of the user, relative to the information in business system 102, as a whole. It displays a rank 340, a user 342 that holds that rank, a number of points 344 corresponding to the user, and any recognition, medals, or other achievements obtained by the user as indicated by block 346. The rank can be calculated in a wide variety of different ways. For instance, generator 168 can combine the various expertise quotients for each user, relative to the various entities in system 102, in order to obtain an overall score (or number of points) for that user. Alternatively, the expertise quotients can be weighted, based upon the various entities. Further, the expertise quotients can be calculated for each individual data source 110-122, and combined to obtain an overall number of points. A wide variety of other methods of calculating the number of points and their rank can be used as well, and those described above with respect to FIG. 4F are examples only.

Display 356 also illustratively includes a display element 348 that displays activity of the user. In the example shown, the activity is described in terms of making updates or modifications to graph 128 or otherwise interacting with graph 128.

It can thus be seen that the present system significantly improves the overall performance of business system 102. It aggregates information to obtain an overall, comprehensive view, of various entities represented in the different parts of business system 102. This allows business system 102 to surface relevant information much more quickly. It also allows system 102 to surface the information, without undergoing numerous searches by various users attempting to find that information. For instance, the users need not search the information in all the different data sources 110-122, in order to obtain the relevant information. Instead, they simply need to conduct one search through graph 128. This significantly reduces the processing and other search overhead of system 122, improving its performance. It also significantly improves the efficiency of the users. Because the users can quickly and easily obtain a single, comprehensive view corresponding to an entity in system 102, it is more likely that the information will be accurate and up to date. It also enables the user to get this by performing a single search instead of searching through multiple different data sources in order to attempt to find the most up to date and credible information. Further, the system is scalable and extensible in that additional data sources can easily be added and crawled to augment graph 128.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

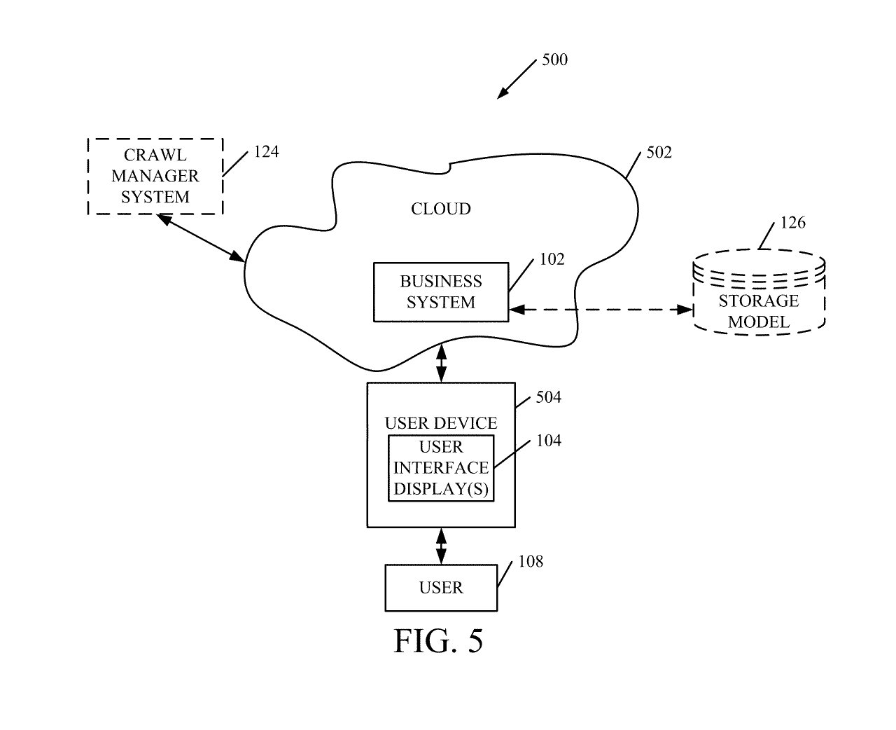

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that business system 102 can be located in cloud 502 (which can be public, private, or a combination where portions are public while others are private). Therefore, user 104 uses a user device 504 to access those systems through cloud 502.

FIG. 5 also depicts another example of a cloud architecture. FIG. 5 shows that it is also contemplated that some elements of architecture 100 can be disposed in cloud 502 while others are not. By way of example, data store 126 can be disposed outside of cloud 502, and accessed through cloud 502. In another example, crawl manager system 124 (or other items) can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

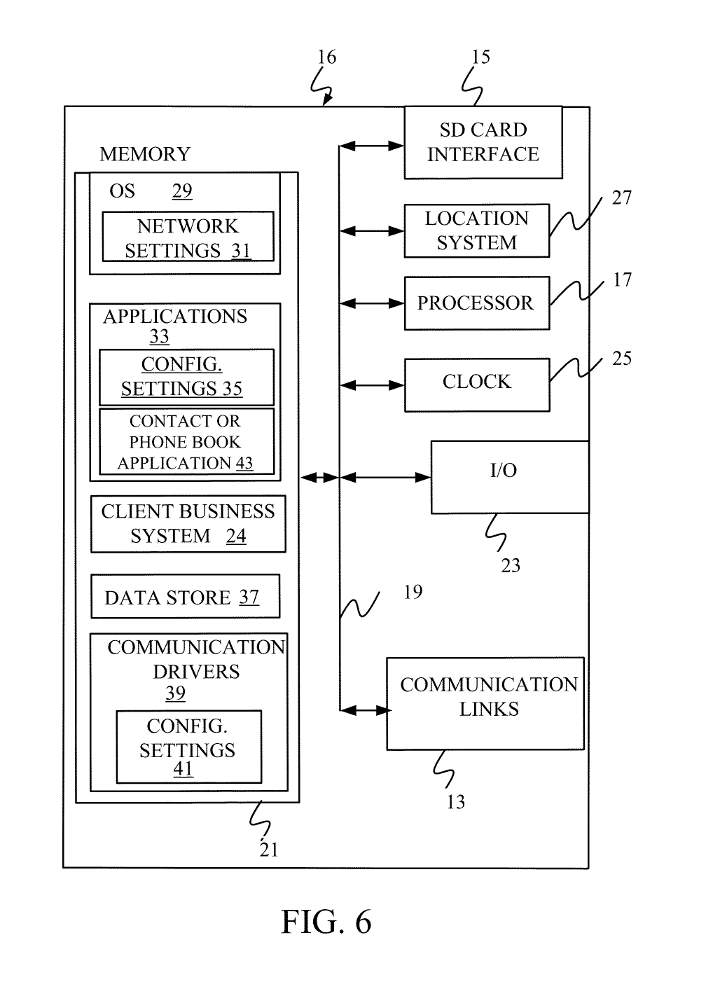

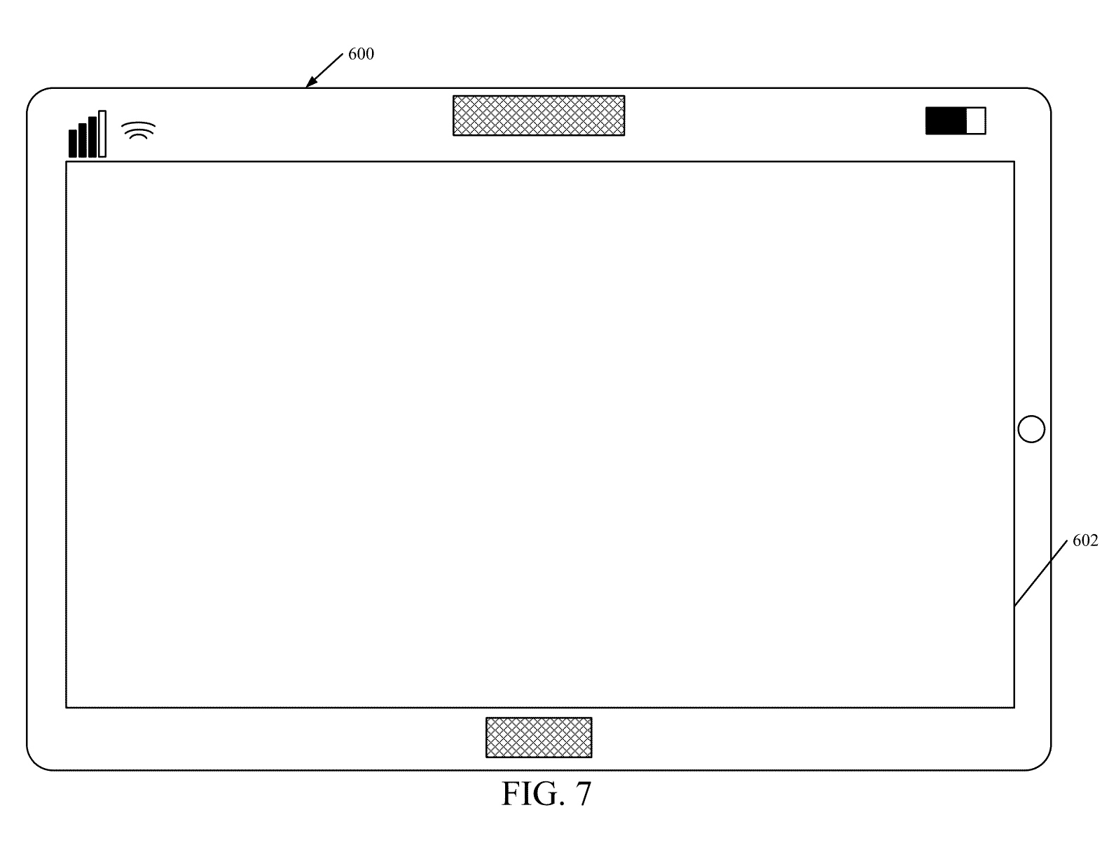

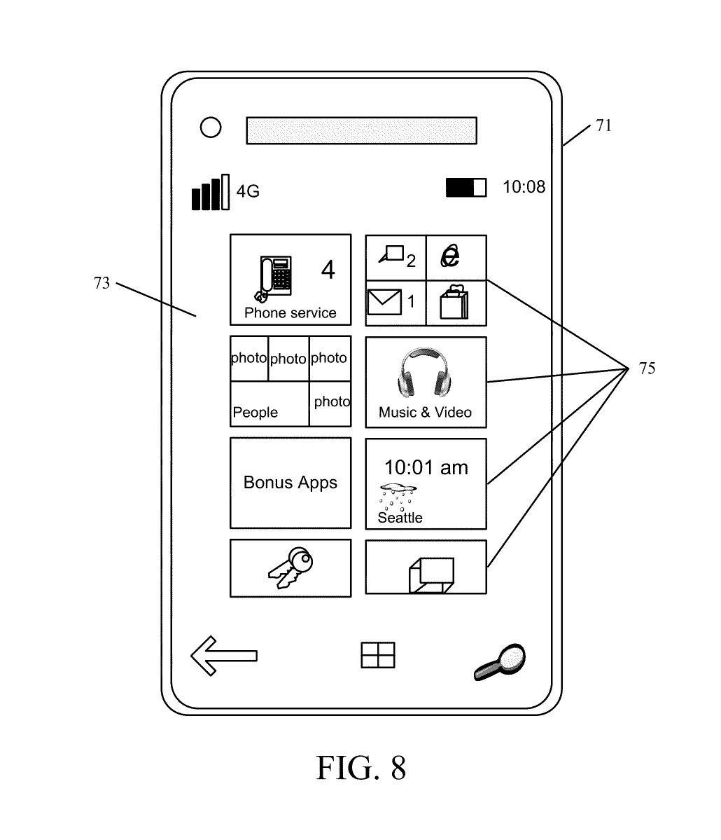

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor/servers 138 or those in device 504) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some embodiments, the phone also includes a Secure Digital (SD) card slot that accepts a SD card.

The mobile device can be a personal digital assistant (PDA) or a multimedia player or a tablet computing device, etc. (hereinafter referred to as PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. Although not shown, the PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

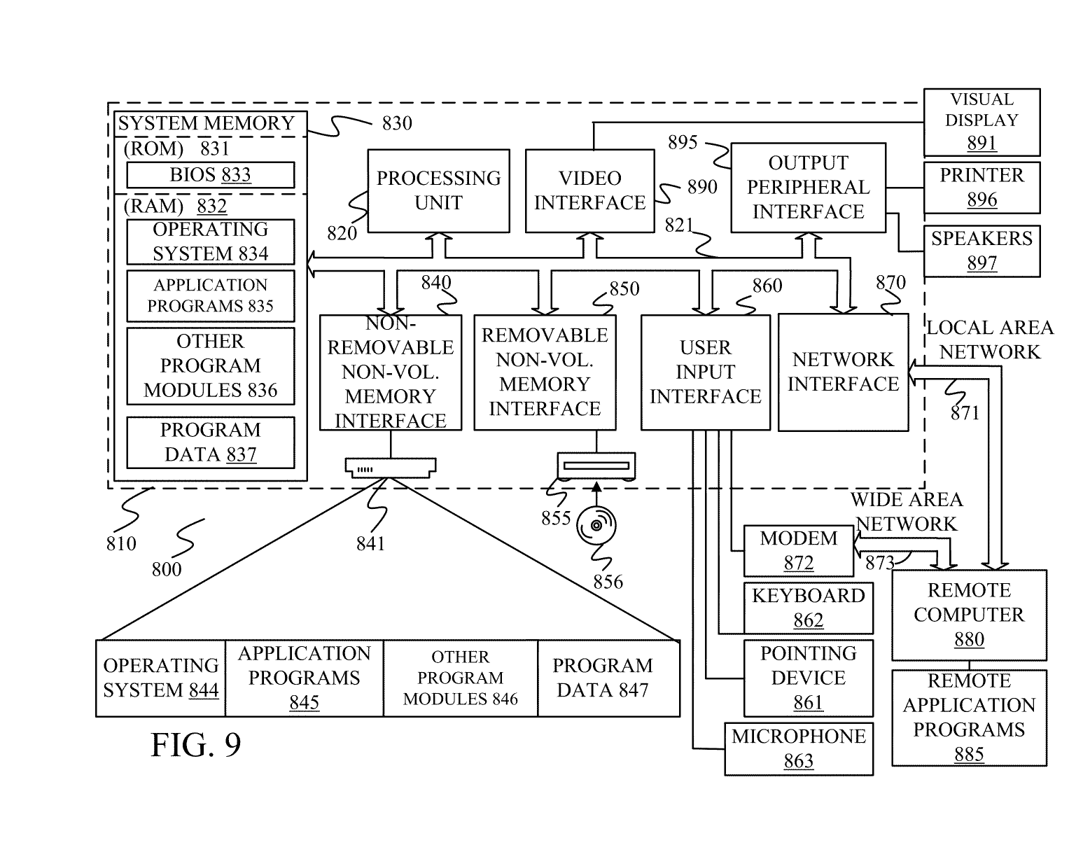

FIG. 9 is one example of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor/server 138 or those in device 504), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a graph builder component that generates a graph having nodes connected by connections, the nodes representing items in the computing system and the connections representing relationships between connected nodes;

a crawl system that crawls a plurality of different data sources, each data source corresponding to a different portion of the computing system and having its own data store, to identify updates to the graph, the graph building component augmenting the graph to include the updates; and

a manual update component that generates update user input mechanisms that are actuated to provide manual updates to the graph.

Example 2 is the computing system of any or all previous examples wherein the plurality of different data sources comprise business systems that perform business functions for an organization that deploys the computing system, each of the business systems including a separate data store that stores at least some system-specific information for at least some of the items represented by the nodes in the graph.

Example 3 is the computing system of any or all previous examples and further comprising:

a conflict resolution component that identifies competing updates for a given node in the graph and identifies a prevailing update that is written to the graph.

Example 4 is the computing system of any or all previous examples wherein the conflict resolution component comprises:

an update ranking engine that ranks the competing updates relative to one another to identify the prevailing update.

Example 5 is the computing system of any or all previous examples wherein the update ranking engine comprises:

a geolocation ranking component that obtains geolocation information identifying a geographic location for each user that has initiated a competing update and for an item represented by the given node, calculates a physical distance each of the users is from the item represented by the given node and ranks the competing updates based on the physical distances calculated.

Example 6 is the computing system of any or all previous examples wherein the update ranking engine comprises:

a time ranking component that obtains time information indicative of a time corresponding to each of the competing updates and ranks the competing updates based on the time information.

Example 7 is the computing system of any or all previous examples and further comprising:

an expertise measure generator calculates an expertise measure for each user relative to the item represented by the given node.

Example 8 is the computing system of any or all previous examples wherein the update ranking engine comprises:

an expertise measure ranking component that obtains the expertise measure for each user that has initiated a competing update, relative to the item represented by the given node and ranks the competing updates based on the obtained expertise measures.

Example 9 is the computing system of any or all previous examples and further comprising:

a recommendation engine that obtains user/node relationship information indicative of relationships between users and nodes in the graph and, based on the user/node information, generates, for a given user, recommendation user input mechanisms indicative of recommended nodes that are recommended for update by the given user.

Example 10 is the computing system of any or all previous examples and further comprising:

a user/node matrix engine that generates a user/node matrix indicative of the user/node relationship information, the recommendation engine accessing the user/node matrix to obtain the user/node relationship information for the given user.

Example 11 is the computing system of any or all previous examples wherein the crawl system comprises:

a plurality of different crawler agents, each corresponding to a different data source; and

a scheduler component that schedules each of the different crawler agents to crawl the corresponding data source to identify the updates.

Example 12 is the computing system of any or all previous examples wherein each crawler agent implements an application programming interface for interaction with its corresponding data source.

Example 13 is the computing system of any or all previous examples and further comprising:

a query engine that generates user input mechanisms that are actuated to receive a user query, execute the user query against the graph, and return a data set indicative of results of executing the query.

Example 14 is a method, comprising:

generating an update user interface display with an update user input mechanism that is actuated to receive a user update to a graph of nodes corresponding to objects in a computing system and connectors representing relationships between connected nodes;

receiving actuation of the update user input mechanism from a first user to receive a first update to a given node;

identifying a second update to the given node, initiated by a second user, that conflicts with the first update;

obtaining geolocation information indicative of a geographic location of the first user, the second user and the object corresponding to the given node; and

identifying a prevailing update, of the first and second updates, based on the geolocation information; and

updating the given node in the graph with the prevailing update.

Example 15 is the method of any or all previous examples wherein obtaining geolocation information comprises:

identifying a first geographic distance between the first user and the object; and

identifying a second geographic distance between the second user and the object.

Example 16 is the method of any or all previous examples and further comprising:

crawling a plurality of different data sources, each data source corresponding to a different system in the computing system and having its own data store, to identify data source updates to the graph; and

augmenting the graph to include the data source updates.

Example 17 is the method of any or all previous examples wherein the plurality of different data sources comprise business systems that perform business functions for an organization that deploys the computing system, each of the business systems including a separate data store that stores at least some system-specific information for at least some of the items represented by the nodes in the graph, and wherein crawling comprises:

crawling each of the different data sources with a different crawling agent.

Example 18 is a computing system, comprising:

a plurality of different crawler agents, each crawler agent crawling a different corresponding data source of a plurality of different data sources, each data source corresponding to a different system within a computing system and having its own data store, each crawler agent identifying updates stored in the data store of the data source corresponding to the given crawler agent;

a graph update component that updates a graph having nodes connected by connections, based on the identified updates, the nodes representing items in the computing system and the connections representing relationships between connected nodes; and

a conflict resolution component that identifies competing updates for a given node in the graph and identifies a prevailing update that is written to the graph by the graph update component.

Example 19 is the computing system of any or all previous examples wherein the competing updates are initiated by different users, wherein the conflict resolution component comprises:

a geolocation ranking component that obtains, from the graph, a geographic location of each of the different users and of an item represented by the given node and ranks the competing updates based on a geographic distance each of the different users is from the item.

Example 20 is the computing system of any or all previous examples and further comprising:

a recommendation engine that generates and displays a list of recommended nodes for update by a given user, based on past updates identified for the given user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a graph builder component that generates a graph having nodes connected by connections, the nodes representing items in the computing system and the connections representing relationships between connected nodes;
a crawl system that crawls a plurality of different data sources, each data source corresponding to a different portion of the computing system and having its own data store, to identify updates to the graph, the graph building component augmenting the graph to include the updates; and
a manual update component that generates update user input mechanisms that are actuated to provide manual updates to the graph.

2. The computing system of claim 1 wherein the plurality of different data sources comprise business systems that perform business functions for an organization that deploys the computing system, each of the business systems including a separate data store that stores at least some system-specific information for at least some of the items represented by the nodes in the graph.

3. The computing system of claim 2 and further comprising:
a conflict resolution component that identifies competing updates for a given node in the graph and identifies a prevailing update that is written to the graph.

4. The computing system of claim 3 wherein the conflict resolution component comprises:
an update ranking engine that ranks the competing updates relative to one another to identify the prevailing update.

5. The computing system of claim 4 wherein the update ranking engine comprises:
a geolocation ranking component that obtains geolocation information identifying a geographic location for each user that has initiated a competing update and for an item represented by the given node, calculates a physical distance each of the users is from the item represented by the given node and ranks the competing updates based on the physical distances calculated.

6. The computing system of claim 5 wherein the update ranking engine comprises:
a time ranking component that obtains time information indicative of a time corresponding to each of the competing updates and ranks the competing updates based on the time information.

7. The computing system of claim 6 and further comprising:
an expertise measure generator calculates an expertise measure for each user relative to the item represented by the given node.

8. The computing system of claim 7 wherein the update ranking engine comprises:
an expertise measure ranking component that obtains the expertise measure for each user that has initiated a competing update, relative to the item represented by the given node and ranks the competing updates based on the obtained expertise measures.

9. The computing system of claim 4 and further comprising:
a recommendation engine that obtains user/node relationship information indicative of relationships between users and nodes in the graph and, based on the user/node information, generates, for a given user, recommendation user input mechanisms indicative of recommended nodes that are recommended for update by the given user.

10. The computing system of claim 9 and further comprising:
a user/node matrix engine that generates a user/node matrix indicative of the user/node relationship information, the recommendation engine accessing the user/node matrix to obtain the user/node relationship information for the given user.

11. The computing system of claim 3 wherein the crawl system comprises:
a plurality of different crawler agents, each corresponding to a different data source; and
a scheduler component that schedules each of the different crawler agents to crawl the corresponding data source to identify the updates.

12. The computing system of claim 11 wherein each crawler agent implements an application programming interface for interaction with its corresponding data source.

13. The computing system of claim 1 and further comprising:
a query engine that generates user input mechanisms that are actuated to receive a user query, execute the user query against the graph, and return a data set indicative of results of executing the query.

14. A method, comprising:
generating an update user interface display with an update user input mechanism that is actuated to receive a user update to a graph of nodes corresponding to objects in a computing system and connectors representing relationships between connected nodes;
receiving actuation of the update user input mechanism from a first user to receive a first update to a given node;
identifying a second update to the given node, initiated by a second user, that conflicts with the first update;
obtaining geolocation information indicative of a geographic location of the first user, the second user and the object corresponding to the given node; and
identifying a prevailing update, of the first and second updates, based on the geolocation information; and
updating the given node in the graph with the prevailing update.

15. The method of claim 14 wherein obtaining geolocation information comprises:
identifying a first geographic distance between the first user and the object; and
identifying a second geographic distance between the second user and the object.

16. The method of claim 15 and further comprising:
crawling a plurality of different data sources, each data source corresponding to a different system in the computing system and having its own data store, to identify data source updates to the graph; and
augmenting the graph to include the data source updates.

17. The method of claim 1 wherein the plurality of different data sources comprise business systems that perform business functions for an organization that deploys the computing system, each of the business systems including a separate data store that stores at least some system-specific information for at least some of the items represented by the nodes in the graph, and wherein crawling comprises:
crawling each of the different data sources with a different crawling agent.

18. A computing system, comprising:
a plurality of different crawler agents, each crawler agent crawling a different corresponding data source of a plurality of different data sources, each data source corresponding to a different system within a computing system and having its own data store, each crawler agent identifying updates stored in the data store of the data source corresponding to the given crawler agent;
a graph update component that updates a graph having nodes connected by connections, based on the identified updates, the nodes representing items in the computing system and the connections representing relationships between connected nodes; and
a conflict resolution component that identifies competing updates for a given node in the graph and identifies a prevailing update that is written to the graph by the graph update component.

19. The computing system of claim 18 wherein the competing updates are initiated by different users, wherein the conflict resolution component comprises:
a geolocation ranking component that obtains, from the graph, a geographic location of each of the different users and of an item represented by the given node and ranks the competing updates based on a geographic distance each of the different users is from the item.

20. The computing system of claim 19 and further comprising:
a recommendation engine that generates and displays a list of recommended nodes for update by a given user, based on past updates identified for the given user.
